(19) United States
(12) Patent Application Publication
(10) Pub. No.: US 2007/0089170 A1
(43) Pub. Date: Apr. 19, 2007

(54) Computer system and security method therefor

(75) Inventors: Yu-Hui Chen, Tao Yuan Shien (TW); Chun-Yi Lu, Tao Yuan Shien (TW)

Correspondence Address: RABIN & Berdo, PC, 1101 14TH STREET, NW, SUITE 500, WASHINGTON, DC, 20005, US

(73) Assignee: Quanta Computer Inc., TaoYuan Shien (TW)

(21) Appl. No.: 11/500,400

(22) Filed: Aug. 8, 2006

(30) Foreign Application Priority Data
Oct. 14, 2005 (TW) 94135947

(51) Int. Cl. H04L 9/32

(52) U.S. Cl. 726/20

(57) ABSTRACT

A computer system and a security method therefor are provided. By the design of storing a basic input/output system (BIOS) in a removable memory and disposing a slot on the host of the computer system for receiving the removable memory, the removable memory can be disconnected from or connected to the host selectively. When the removable memory is unplugged from the host, the host will not be booted up or woke up due to the lack of the BIOS, hence achieving a thorough computer security function.

This application claims the benefit of Taiwan application Serial No. 94135947, filed Oct. 14, 2005, the subject matter of which is incorporated herein by reference.

### BACKGROUND OF THE INVENTION

1. Field of the Invention

The invention relates in general to a computer system and a security method therefor, and more particularly to a computer system using a removable memory having a basic input/output system (BIOS) and a security method therefor.

2. Description of the Related Art

Examples of conventional computer security method include smart card, fingerprint reader and booting passwords of a basic input/output system (BIOS).

Typically, the current computer security method achieved by using a smart card only restricts the connection to the Internet, that is, only after a corresponding smart card is inserted can the computer be connected to relevant networks. However, the above method does not check the security of the computer when the computer is booted up or woke up from a power-saving mode. In this case, any other person is able to activate the computer in the absence of a smart card except that the other person can not enter relevant networks. Therefore, the data stored in the computer is not well protected.

The computer security method achieved by using a fingerprint reader identifies the fingerprint of the user when the computer system is booted up. Only after the identification is authenticated can the computer be booted up. However, the computer security method achieved by using a fingerprint reader has a number of disadvantages. For example, the hardware of the fingerprint reader is costive, a corresponding device and software for fingerprint identification are required, and when the fingerprint reader applied in a notebook computer, part of the space is occupied, incapacitating further reduction in the volume of the notebook computer.

Another example of computer security method which has been used for a long time is the setting of booting passwords in the BIOS. When the computer system is booted up, the user is requested to input the passwords, and only after the passwords are authenticated will the computer be booted up. However, when the operating system of the computer which had been switched to a power-saving mode, such as a standby mode or a hibernation mode, is now woke up, the BIOS of the computer system does not request the booting passwords to be inputted and authenticated again. Consequently, after the computer enters the power-saving mode, everyone can wake the computer up.

None of the security methods disclosed above including the use of the smart card, the fingerprint reader and the booting passwords of BIOS can provide a thorough computer security function. Therefore, how to provide a thorough computer security function capable of thoroughly protecting computer data has become an urgent issue to be resolved.

### SUMMARY OF THE INVENTION

It is therefore an object of the invention to provide a computer system and a security method therefor to achieve a thorough computer security.

The invention achieves the above-identified object by providing a computer system including a host and a removable memory. The host includes a slot corresponding to the removable memory. The removable memory is used for storing a basic input/output system (BIOS) of the host. The slot is used for selectively receiving the removable memory, so that the host can read/write data with respect to the removable memory via the slot. When the host is booted up, the removable memory is received in the slot already.

The invention further achieves the above-identified object by providing a security method for a computer system. The computer system has a host. The method for achieving computer system security includes the following steps. At first, a removable memory is plugged into a corresponding slot disposed on the host. The removable memory is used for storing a basic input/output system (BIOS) of the host. Next, the host is booted up to enter an active mode.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrates a computer system according to a preferred embodiment of the invention; and

FIG. 2 is a diagram of the computer system according to the preferred embodiment of the invention.

### DETAILED DESCRIPTION OF THE INVENTION

The invention provides a thorough computer security method. By the design of storing a basic input/output system (BIOS) in a removable memory or by designing the removable memory in the form of a memory card and disposing corresponding slots on the host, the removable memory or the memory card is able to be selectively disconnected from or connected to the host via the corresponding slot. Thus, when the removable memory or the memory card is unplugged from the host, the host will not be booted up or woke up from a power-saving mode due to the lack of the BIOS, hence providing a thorough computer security method.

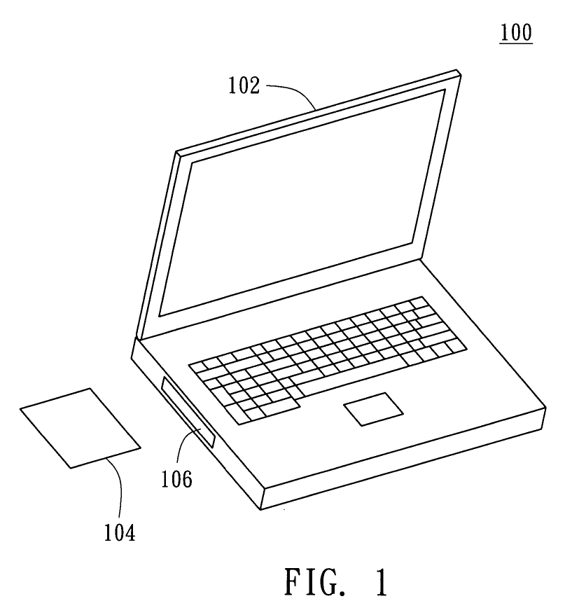

Referring to FIG. 1, a computer system according to a preferred embodiment of the invention is shown. Examples of the computer system 100 include desktop computer, server, barebone, notebook computer or personal digital mobile device. Examples of the personal digital mobile device include personal digital assistant (PDA). In the present embodiment of the invention, the computer system 100 is exemplified by a notebook computer. The computer system 100 includes a host 102 and a removable memory 104. The host 102 includes a slot 106 corresponding to the removable memory 104. Examples of the slot 106 include the slot for SD (secure digital memory card)/MMC (multi media card)/SM (smart media)/SMM/XD memory card. The slot 106 is used for receiving the removable memory 104. Examples of the removable memory 104 include SD (secure digital memory card)/MMC (multi media card)/SM (smart media)/SMM/XD memory card. The removable memory 104 is for storing the BIOS. The BIOS is used for controlling the environmental settings and the power management program for booting up and operating the computer system 100. Examples of the environmental setting include setting the peripheral equipment and communication addresses.

Furthermore, the removable memory 104 is exemplified by a memory card. The slot 106 has a number of pins corresponding to the memory card 104. The host 102 electrically connected to the memory card 104 via the pins can read/write data with respect to the memory card 104. Examples of the communication interface between the BIOS of the memory card 104 and the computer system 100 include X-BUS/LPC/SPI. The present embodiment of the invention does not limit the types of the communication interface and the pins of the slot 106. That is, any pin which corresponds to the type of the memory card 104 and enables the memory card 104 to transmit signals with the host 102 can be used in this embodiment. One of the pins is defined as a system security detecting pin PIN (X) (not shown in FIG. 1). The system security detecting pin PIN (X) enables the voltage level of the system security detecting pin PIN (X) to be changed when the memory card 104 is plugged into or unplugged from the slot 106.

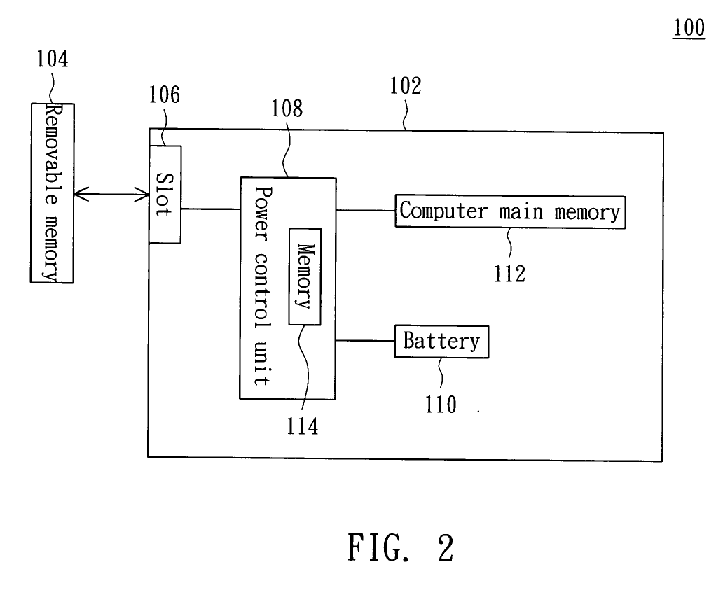

Referring to FIG. 2, a diagram of the computer system according to the preferred embodiment of the invention is shown. Examples of the computer system 100 include a notebook computer. The host 102 includes a memory card 104, a corresponding slot 106, a power control unit 108, a battery 110 and a main memory 112 of the host 102 or the computer system 100. The battery 110 provides power to the host 102 without using an external power source such as an electrical supply of AC 110 volts. Examples of the power control unit 108 include an embedded control IC. The power control unit 108 controlling the power source of the host 102 is used for executing a power management program and a system security program. The power control unit 108 further includes a memory 114. The power management program includes the power management program for the main memory 112 and a charging/discharging program for the battery 110. For example, the power control unit 108 is used for controlling the charging/discharging of the battery 110 and calculating the residual power of the battery 110, or controlling the power source of the main memory 112. Examples of the main memory 112 include DRAM and SDRAM.

The system security program is used for determining whether the memory card 104 is plugged into the slot 106. For example, when the user activates the power source of the computer system 100, the power control unit 108 determines whether the memory card 104 is received in the slot 106 according to the detected electrical potential at the system security detecting pin PIN (X). For example, when the memory card 104 is not received in the slot 106, the electrical potential at the pin PIN (X) is at a low level (logic 0), so the power control unit 108, according to the low electrical potential at the pin PIN (X), determines that the memory card 104 has been unplugged. Therefore, when the memory card 104 is not received in the slot 106, the power control unit 108 will not activate the host 102. For example, when the host 102 is originally at a power-off mode and does not receive the memory card 104, the relevant electric components does not receive the power source and can not be booted up despite the power source is activated. Therefore, in the absence of the BIOS, the host will not be booted up when the power source is activated by mistake, lest the power might be wasted or the electric components of the host 102 might be damaged.

The memory card 104 can be defined as a system security lock of the computer system 100. Only when the memory card 104 is plugged into the slot 106 and is connected to the host 102 can the host 102 be activated to enter an active mode. Currently, after an operating system, such as the Windows OS, is executed by the computer system 100, there are several relevant modes such as, power-saving mode (standby mode or hibernation mode) available other than the active mode and the power-off mode. Under the standby mode, part of the power management program is executed by the power control unit 108 to maintain the power source for the main memory 112 of the host 102 or the computer system 100, the system security program is also be executed to determine whether the memory card 104 is connected to the host 102. Under the hibernation mode or the power-off mode, the power control unit 108 executes the system security program to determine whether the memory card 104 is connected to the host 102. Therefore, only when the host 102 is at the power-saving mode or the power-off mode and the memory card 104 is plugged into the slot 106 to connect to the host 102 can the host 102 be woke up or booted up to an active mode.

Under the circumstances that the power management program and the system security program are stored in the memory card 104, when the host 102 enters a power-saving mode or a power-off mode, the power control unit 108 will move the power management program and the system security program to the memory 114 of the power control unit 108 and turn the power source of the memory card 104 off, so the memory card 104 can be unplugged from the slot 106. When the host 102 is to be booted up or woke up, the memory card 104 has to be plugged into the slot for enabling the host 102 to enter an active mode, hence assuring system security. It is noted that the power management program and the system security program are stored in the memory card 104. If the host 102 is powered by an external power source or a battery 110, the system security program has to be copied to the memory 114 of the power control unit 108 when the host 102 enters a power-off mode or a power-saving mode. If the external power source and the battery 110 are both available at the same time, the power management program has to be copied to the memory 114 of the power control unit 108 for enabling the battery 110 to be charged or discharged.

Likewise, when the power management program and the system security program are stored in memory card 104, another possibility arises. If the host 102 is powered by an external power source or a battery, when the host 102 enters a standby mode, apart form the system security program, the power management program also has to be copied to the memory 114 of the power control unit 108 for enabling the power control unit 108 to maintain the power source of the main memory 112. Similarly, if the external power source and the battery 110 are both available at the same time, the power management program also has to be copied to the, memory 114 of the power control unit 108 for enabling the battery 110 to be charged or discharged.

To the contrary, if both the power management program and the system security program are stored in the memory 114 of the power control unit 108 instead of the memory card 104, when the host 102 is shut down or enters a power-saving mode including the standby mode and the hibernation mode, the power control unit 108 will turn off the power source of the memory card 104. Meanwhile, no matter whether the computer system 100 is a notebook computer or not, the memory card 104 can be removed from the slot 106 directly.

The slot 106 includes relevant protection designs such as a mistake-proofing design which prevents the user from plugging the memory card 104 in the wrong direction, a structural design which prevents the memory card 104 when received in the slot 106 from coming off the slot, and a structural design which prevents the memory card 104 from coming off the slot 106 when the host 102 continues providing power to the memory card 104 (for example, when the power supply is still received through the LPC interface of the BIOS). The above designs ascertain that data loss will not occur to the computer system 100 in the case when the memory card 104 is unplugged inappropriately or comes off the slot unexpectedly.

According to the computer system and the security method therefor disclosed in the above embodiments of the invention, a BIOS is stored in a memory card. That is, the BIOS ROM is separated from the system and designed to be a memory card, and the memory card is further defined as a system security lock. Only when the memory card is received in the host can the host have the BIOS to operate the system. For example, the host can be booted up or activated from a power-saving mode as the memory card is received in the slot. That is, the memory card can be unplugged after the host is shut down or enters a power-saving mode. In the absence of the memory card (also referred as system security lock), the host lacking the BIOS can not be booted up or activated from the power-saving mode, hence assuring computer security.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A computer system, comprising:
a host having a slot; and
a removable memory corresponding to the slot for storing a basic input/output system (BIOS) of the host;
wherein the slot is for selectively receiving the removable memory for enabling the host to read data with respect to the removable memory via the slot, and when the removable memory is inserted into the slot and connected to the host, the host enters an active mode.

2. The computer system according to claim 1, wherein when the host is shut down or enters a power-saving mode, the removable memory can be unplugged from the slot.

3. The computer system according to claim 2, wherein the power-saving mode comprises a standby mode and a hibernation mode.

4. The computer system according to claim 1, wherein the host further write data with respect to the removable memory via the slot.

5. The computer system according to claim 1, wherein the host further comprises:
a power control unit for determining whether the slot receives the removable memory, and when the slot does not receive the removable memory, the power control unit incapacitates the host from being booted up or woke up from a power-saving mode.

6. The computer system according to claim 5, wherein the power control unit, by detecting the electrical potential at a pin of the slot, determines that the slot does not receive the removable memory and incapacitates the host from being booted up or woke up from the power-saving mode.

7. The computer system according to claim 1, wherein the computer system includes a notebook computer.

8. The computer system according to claim 1, wherein the removable memory includes a memory card.

9. The computer system according to claim 1, wherein when the removable memory receives a power source, the removable memory can not be unplugged from the slot.

10. A security method for a computer system, wherein the computer system has a host, and the method comprises:
plugging a removable memory into a corresponding slot disposed on the host, wherein the removable memory is for storing a basic input/output system (BIOS) of the host; and
activating the host to enter an active mode.

11. The security method according to claim 10, wherein the step of activating the host further comprises:
when the host is at a power-off mode and the removable memory is plugged into the slot, the host can be booted up.

12. The security method according to claim 10, wherein the step of activating the host further comprises:
when the host is at a power-saving mode and the removable memory is plugged into the slot, the host can be woke up.

13. The security method according to claim 10, further comprising:
detecting the electrical potential at a pin of the slot to determine whether the slot receives the removable memory.

14. The security method according to claim 10, further comprising:
when the host enter a power-saving mode or a power-off mode, the host copies a power management program and a system security program to be executed in a memory, wherein the power management program and the system security program are stored in the removable memory, the power management program is for controlling the power source of the host, the system security program is for determining whether the removable memory is plugged into the slot, and the memory is disposed on the host;
turning off the power source of the removable memory; and
unplugging the removable memory from the slot.

15. The security method according to claim 14, wherein the power management program comprises the charging/discharging program for a battery, the battery is installed in the host, and the computer system includes a notebook computer.

16. The security method according to claim 14, wherein the power management program comprises the power management program for a main memory of the host, and the computer system includes a notebook computer.

17. The security method according to claim 14, wherein the power-saving mode comprises a standby mode and a hibernation mode.
